(19) United States
(12) Patent Application Publication
(10) Pub. No.: US 2015/0184939 A1
(43) Pub. Date: Jul. 2, 2015

(54) BLAST FURNACE INSTALLATION

(71) Applicant: MITSUBISHI HEAVY INDUSTRIES, LTD., Tokyo (JP)

(72) Inventors: Keiichi Nakagawa, Tokyo (JP); Setsuo Omoto, Tokyo (JP); Masakazu Sakaguchi, Tokyo (JP); Tsutomu Hamada, Tokyo (JP)

(73) Assignee: MITSUBISHI HEAVY INDUSTRIES, LTD., Tokyo (JP)

(21) Appl. No.: 14/415,897

(22) PCT Filed: Sep. 5, 2013
(86) PCT No.: PCT/JP2013/073878

§ 371 Date: Jan. 20, 2015

(30) Foreign Application Priority Data
Sep. 20, 2012 (JP) 2012-206776

(51) Int. Cl. F27B 1/26; C21B 7/00; F27D 3/18; F27B 1/16; F27B 1/28; C21B 7/16; C21B 5/00

(52) U.S. Cl. CPC F27B 1/26; C21B 7/16; C21B 7/00; C21B 5/003; F27B 1/16; F27B 1/28; F27D 3/18

(57) ABSTRACT

A blast furnace installation (100) equipped with a blast furnace body (110), a hot air blowing means (114, 115, etc.) for blowing hot air into the blast furnace body (110) through a tuyere, and a pulverized coal supply means for supplying pulverized coal (2) into the blast furnace body (110) through the tuyere. The pulverized coal (2) is obtained by means of dry distillation of low-grade coal. The pulverized coal supply means is equipped with: a pneumatic conveying means (115-120) for pneumatically conveying the pulverized coal (2) to the tuyere by means of a carrier gas (107) made of a mixture of air (106) and an inert gas (102); a temperature sensor (121) for detecting the temperature of the carrier gas (107) near the tuyere; and a control unit (122) for adjusting the mixing ratio between the air (106) and the inert gas (102) in the carrier gas (107) of the pneumatic conveying means (115-120) on the basis of information from the temperature sensor (121).

### TECHNICAL FIELD

The present invention relates to a blast furnace installation.

### BACKGROUND ART

Blast furnace installations have been configured so as to be capable of producing pig iron from iron ore by charging a starting material such as iron ore, limestone, or coal from the top into the interior of the blast furnace body and blowing hot air and pulverized coal (pulverized coal injection: PCI coal) as auxiliary fuel from a tuyere disposed at a lower portion on the side of the blast furnace body.

### CITATION LIST

### Patent Documents

Patent Document 1: Japanese Unexamined Patent Application Publication No. H4-093512A

Patent Document 2: Japanese Unexamined Patent Application Publication No. H10-060508A

Patent Document 3: Japanese Unexamined Patent Application Publication No. H11-092809A

Patent Document 4: Japanese Unexamined Patent Application Publication No. 2007-239019A

### SUMMARY OF THE INVENTION

### Technical Problem

If the PCI coal blown into the interior of the blast furnace body as auxiliary fuel generates unburned carbon, there is the possibility of the unburned carbon obstructing the flow of combustion gas. Therefore, since high combustion performance is required, expensive, high-grade anthracite coal, bituminous coal, or the like is used, causing an increase in the production cost of pig iron.

Accordingly, an object of the present invention is to provide a blast furnace installation that can reduce the production cost of pig iron.

### Solution to Problem

To solve the above problem, the blast furnace installation pertaining to the first invention is a blast furnace installation equipped with a blast furnace body, a starting material charging means for charging starting material from a top into an interior of the blast furnace body, a hot air blowing means for blowing hot air into the blast furnace body through a tuyere, and a pulverized coal supply means for supplying pulverized coal into the blast furnace body through the tuyere, wherein the pulverized coal is obtained by means of dry distillation of low-grade coal, and the pulverized coal supply means is equipped with a pneumatic conveying means for pneumatically conveying the pulverized coal to the tuyere by means of a carrier gas made of a mixture of air and an inert gas; a carrier gas state detection means for detecting a state of the carrier gas near the tuyere; and a control means for adjusting the mixing ratio between the air and the inert gas in the carrier gas of the pneumatic conveying means on the basis of information from the carrier gas state detection means.

The blast furnace installation pertaining to the second invention is the first invention wherein the carrier gas state detection means of the pulverized coal supply means detects at least one state among the temperature, oxygen concentration, carbon monoxide concentration and carbon dioxide concentration of the carrier gas.

The blast furnace installation pertaining to the third invention is the first or second invention wherein the control means of the pulverized coal supply means adjusts the mixing ratio between the air and the inert gas in the carrier gas of the pneumatic conveying means such that the temperature of the carrier gas is from 200° C. to T° C. (wherein T is the dry distillation temperature of the low-grade coal).

The blast furnace installation pertaining to the fourth invention is any one of the first to third inventions wherein the pulverized coal has been dry-distilled at from 400° C. to 600° C.

The blast furnace installation pertaining to the fifth invention is any one of the first to fourth inventions wherein the pulverized coal has a diameter of not more than 100 μm.

The blast furnace installation pertaining to the sixth invention is any one of the first to fifth inventions wherein the low-grade coal is sub-bituminous coal or lignite.

The blast furnace installation pertaining to the seventh invention is any one of the first to sixth inventions wherein the inert gas is at least one among nitrogen gas, off-gas discharged from the blast furnace body, and combustion exhaust gas after the off-gas has been combusted with air.

### Advantageous Effects of Invention

By the blast furnace installation pertaining to the present invention, the production cost of pig iron can be reduced due to the fact that inexpensive low-grade coal can be used as the blowing coal (PCI coal) because pulverized coal obtained by means of dry distillation of low-grade coal is pneumatically conveyed to a tuyere by means of a carrier gas obtained by mixing air and inert gas, and due to the fact that ignitability (burn-out capability) of the blowing coal (PCI coal) can be improved without providing a heater, heat exchanger or the like for heating the carrier gas and pulverized coal. Furthermore, with improvement of ignitability (burn-out capability) of the blowing coal (PCI coal), the supplied quantity of blowing coal (PCI coal) may be reduced and the production cost of pig iron can be further reduced. Conversely, with improvement of ignitability (burn-out capability) of the blowing coal (PCI coal), the supplied quantity of blowing coal (PCI coal) may be increased, and therefore the quantity of coal (coke) supplied as a starting material to the top of the blast furnace body may be reduced and the production cost of pig iron can be further reduced.

### BRIEF DESCRIPTION OF THE DRAWINGS

FIG. 1 is a schematic configuration diagram of essential parts of a first embodiment of the blast furnace installation pertaining to the present invention.

FIG. 2 is a control system diagram of essential parts of the blast furnace installation of FIG. 1.

FIG. 3 is a schematic configuration diagram of essential parts of a second embodiment of the blast furnace installation pertaining to the present invention.

FIG. 4 is a control system diagram of essential parts of the blast furnace installation of FIG. 2.

### DESCRIPTION OF EMBODIMENTS

Embodiments of the blast furnace installation pertaining to the present invention will be described based on the drawings, but the present invention is not limited only to the following embodiments described based on the drawings.

### First Embodiment

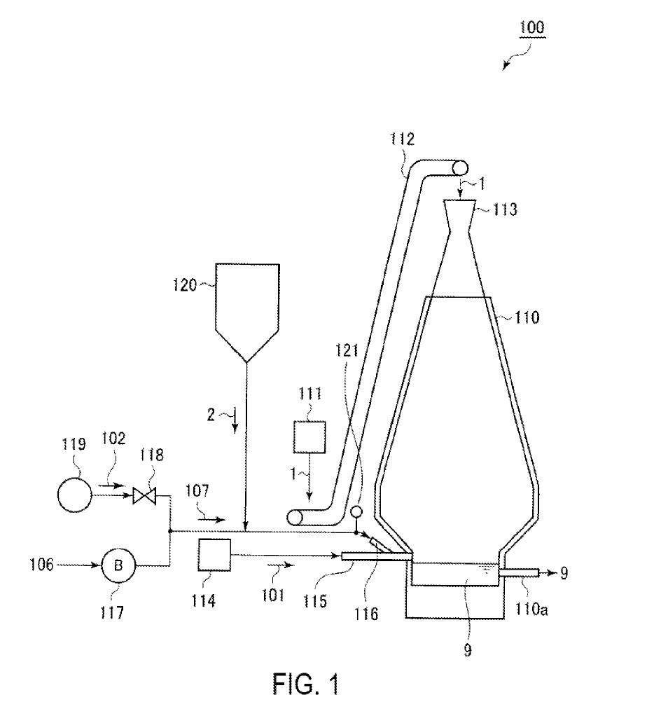

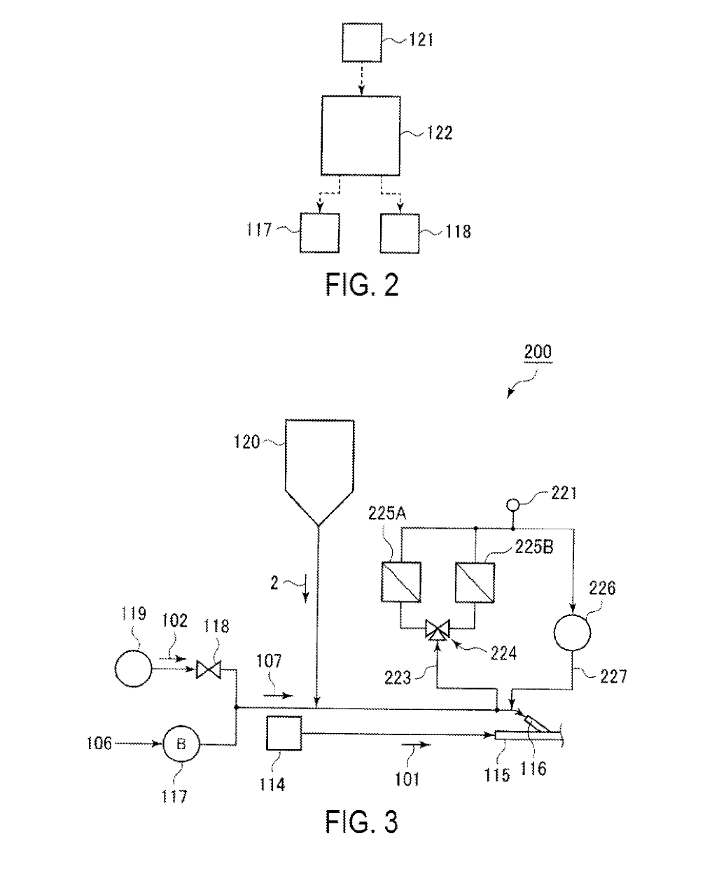

A first embodiment of the blast furnace installation pertaining to the present invention will be described based on FIGS. 1 and 2.

As illustrated in FIG. 1, a starting material dispensing device 111 for dispensing a starting material 1 such as iron ore, limestone or coal is connected on the upstream side of the conveyance direction of a charging conveyor 112 which conveys the starting material 1. On the downstream side of the conveyance direction of the charging conveyor 112, a throat hopper 113 of the top of a blast furnace body 110 is connected. A hot air feeding device 114 which feeds hot air 101 (from 1000° C. to 1300° C.) is connected to a blow pipe 115 provided on a tuyere of the blast furnace body 110.

The distal side of an injection lance 116 is inserted and connected part way along the blow pipe 115. A blast opening of an air blower 117 which feeds air 106 is connected to the proximal side of the injection lance 116. Between the blast opening of the air blower 117 and the proximal side of the injection lance 116, an inert gas supply source 119, which feeds an inert gas 102 such as nitrogen gas or the like is connected via a flow rate adjustment valve 118.

Between the air blower 117 and flow rate adjustment valve 118 and the injection lance 116, the bottom part of a supply tank 120 is connected, wherein pulverized coal 2, obtained by means of dry distillation of low-grade coal such as lignite or sub-bituminous coal at temperature T (from 400° C. to 600° C.) and then pulverizing (diameter not more than 100 μm), may enter the interior of the supply tank 120. The interior of the supply tank 120 can be held in an inert gas atmosphere, and the pulverized coal 2 can be supplied by dropping from the interior.

Near the proximal side of the injection lance 116, that is, near the tuyere, a temperature sensor 121, which is a carrier gas state detection means for detecting the temperature inside the injection lance 116, is provided. As illustrated in FIG. 2, the temperature sensor 121 is electrically connected to the input part of a control unit 122 which is a control means. The output part of the control unit 122 is electrically connected to the air blower 117 and the flow rate adjustment valve 118, and the control unit 122 can control the blast volume of the air blower 117 and the openness of the flow rate adjustment valve 118 on the basis of information from the temperature sensor 121 (details will be described later).

Furthermore, in this embodiment, a starting material charging means is constituted by the starting material dispensing device 111, the charging conveyor 112, the throat hopper 113 and the like; a hot air blowing means is constituted by the hot air feeding device 114, the blow pipe 115 and the like; a pneumatic conveying means is constituted by the blow pipe 115, the injection lance 116, the air blower 117, the flow rate adjustment valve 118, the inert gas supply source 119, the supply tank 120 and the like; and a pulverized coal supply means is constituted by the pneumatic conveying means, the carrier gas state detection means, the control means and the like. Furthermore, in FIG. 1, 110a is a taphole for drawing out melted pig iron (molten iron) 9.

In the blast furnace installation 100 pertaining to this embodiment, the starting material 1 is charged into the blast furnace body 110 by being dispensed from the starting material dispensing device 111 and then being supplied into the throat hopper 113 via the charging conveyor 112, while on the other hand, hot air 101 is fed from the hot air feeding device 114 to the blow pipe 115, and pulverized coal 2 is supplied by dropping from the supply tank 120.

When the control unit 122 is operated, the control unit 122 operates the air blower 117 so as to feed air 106 from the air blower 117, and opens the flow rate adjustment valve 118 so as to feed inert gas 102 from the inert gas supply source 119.

As a result, the pulverized coal 2 is pneumatically conveyed to the injection lance 116 by carrier gas 107 made of a mixture of air 106 and the inert gas 102. At this time, because the pulverized coal 2 has been increased in reactivity by being dry-distilled and because the carrier gas 107 contains oxygen, some of the pulverized coal 2 reacts with oxygen and burns during pneumatic conveyance. For this reason, the carrier gas 107 and the pulverized coal 2 are preheated (from 200° C. to T° C.) by self-heating.

The pulverized coal 2 pneumatically conveyed into the injection lance 116 is supplied together with the carrier gas 107 into the interior of the blow pipe 115, and is supplied from the hot air feeding device 114 into the hot air 101, thereby being burned. At this time, because the carrier gas 107 and the pulverized coal 2 blown into the hot air 101 from the injection lance 116 have been preheated (from 200° C. to T° C.), the ignitability and burn-out capability of the pulverized coal 2 are improved.

Here, if the temperature of the carrier gas 107 blown into the hot air 101 from the injection lance 116, that is, the temperature of the carrier gas 107 near the tuyere, is less than 200° C., the control unit 122 controls the air blower 117 and the flow rate adjustment valve 118 so as to increase the burning capacity of the pulverized coal 2 being pneumatically conveyed to the injection lance 116 on the basis of information from the temperature sensor 121, to increase the blast volume of the air blower 117 and reduce the openness of the flow rate adjustment valve 118 so as to increase the oxygen concentration in the carrier gas 107 while holding the flow rate of the carrier gas 107 constant.

On the other hand, if the temperature of the carrier gas 107 blown into the hot air 101 from the injection lance 116, that is, the temperature of the carrier gas 107 near the tuyere, is greater than T° C., the control unit 122 controls the air blower 117 and the flow rate adjustment valve 118 so as to decrease the burning capacity of the pulverized coal 2 being pneumatically conveyed to the injection lance 116 on the basis of information from the temperature sensor 121, to decrease the blast volume of the air blower 117 and increase the openness of the flow rate adjustment valve 118 so as to decrease the oxygen concentration in the carrier gas 107 while holding the flow rate of the carrier gas 107 constant.

In this manner, the pulverized coal 2 blown into the hot air 101 from the injection lance 116 and burned in the interior of the blow pipe 115 becomes a flame and forms a raceway from the tuyere to the interior of the blast furnace body 110, and burns the coal and the like in the starting material 1 inside the blast furnace body 110. As a result, the iron ore in the starting material 1 is reduced to result in pig iron (molten iron) 9, which is drawn out from the taphole 110a.

In short, in the blast furnace installation 100 pertaining to this embodiment, pulverized coal 2 obtained by means of dry distillation of low-grade coal such as lignite, sub-bituminous coal or the like at temperature T (from 400° C. to 600° C.) and then pulverizing (diameter not more than 100 μm) is used as blowing coal (pulverized coal injection: PCI coal), and a mixed gas of air 106 and inert gas 102 is used as the carrier gas 107 that pneumatically conveys the pulverized coal 2 to the injection lance 116.

For this reason, in the blast furnace installation 100 pertaining to this embodiment, inexpensive low-grade coal can be used as the blowing coal (PCI coal), and ignitability (burn-out capability) of the blowing coal (PCI coal) can be improved without providing a heater, heat exchanger or the like for heating the carrier gas 107 and pulverized coal 2.

Therefore, by the blast furnace installation 100 pertaining to this embodiment, the production cost of pig iron 9 can be reduced.

Furthermore, with improvement of ignitability (burn-out capability) of the blowing coal (PCI coal), the supplied quantity of blowing coal (PCI coal) may be reduced and the production cost of pig iron 9 can be further reduced. Conversely, with improvement of ignitability (burn-out capability) of the blowing coal (PCI coal), the supplied quantity of blowing coal (PCI coal) may be increased, and therefore the quantity of coal (coke) supplied as a starting material 1 to the top of the blast furnace body 110 may be reduced and the production cost of pig iron 9 can be further reduced.

Furthermore, the preheating temperature of the carrier gas 107 and the pulverized coal 2 is preferably from 200° C. to T (dry distillation temperature of pulverized coal 2) ° C. This is because if it is less than 200° C., there is risk that it will be difficult to sufficiently improve the ignitibility (burn-out capability) of the pulverized coal 2, and if it exceeds T (dry distillation temperature of pulverized coal 2) ° C., thermolysis products such as tar end up being produced from the pulverized coal 2, and these thermolysis products adhere to the inner wall surfaces of the injection lance 116 and the like, leading to the risk of blockage of the injection lance 116 and the like.

### Second Embodiment

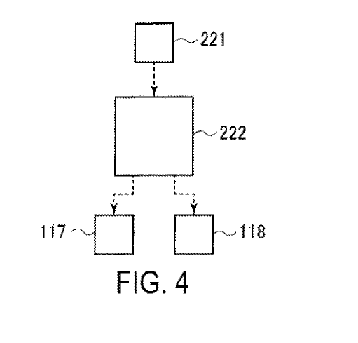

A second embodiment of the blast furnace installation pertaining to the present invention will be described based on FIGS. 3 and 4. Note that the same reference numerals as those used in the description of the embodiment above are used for the portions that are the same as in the embodiment above, and therefore, descriptions that are the same as in the embodiment above are omitted.

As illustrated in FIG. 3, the proximal side of a fractionation line 223 is connected near the proximal end of the injection lance 116 between the injection lance 116 and the supply tank 120. The distal side of the fractionation line 223 is connected to one port of a three-way valve 224. The remaining two ports of the three-way valve 224 are respectively connected to filter devices 225A and 225B.

The outlet ports of the filter devices 225A and 225B are connected to the suction port of a suction pump 226. The outlet port of the suction pump 226 is connected via a return line 227 between the proximal side of the fractionation line 223 and the proximal side of the injection lance 116. A CO sensor 221 which detects the carbon monoxide concentration in the carrier gas 107 fractionated from the fractionation line 223 is provided between the outlet ports of the filter devices 225A and 225B and the suction port of the suction pump 226.

As illustrated in FIG. 4, the CO sensor 221 is electrically connected to the input part of the control unit 222 which is the control means. The output part of the control unit 222 is electrically connected to the air blower 117 and the flow rate adjustment valve 118, and the control unit 222 can control the blast volume of the air blower 117 and the openness of the flow rate adjustment valve 118 on the basis of information from the CO sensor 221 (details will be described later).

Furthermore, in this embodiment, a carrier gas state detection means is constituted by the CO sensor 221, the fractionation line 223, the three-way valve 224, the filter devices 225A and 225B, the suction pump 226, the return line 227 and the like; and a pulverized coal supply means is constituted by the carrier gas state detection means, the control means, the pneumatic conveying means and the like.

In the blast furnace installation 200 pertaining to this embodiment, similar to the embodiment described above, the starting material 1 is charged into the blast furnace body 110, while on the other hand, hot air 101 is fed from the hot air feeding device 114 to the blow pipe 115, and pulverized coal 2 is supplied by dropping from the supply tank 120.

Then, the three-way valve 224 is opened and closed such that only one of the filter devices 225A and 225B (for example, filter device 225A) connects to the fractionation line 223 and the return line 227, and when the suction pump 226 is operated and the control unit 222 is operated, the control unit 222 operates the air blower 117 so as to feed air 106 from the air blower 117, and also opens the flow rate adjustment valve 118 so as to feed inert gas 102 from the inert gas supply source 119, similar to the embodiment described above.

As a result, similar to the embodiment described above, the pulverized coal 2 is pneumatically conveyed to the injection lance 116 by carrier gas 107 made of a mixture of air 106 and the inert gas 102, and is supplied together with the carrier gas 107 to the interior of the blow pipe 115, and is supplied from the hot air feeding device 114 into the hot air 101, thereby being burned.

Here, the carrier gas 107 pneumatically carried to near the proximal side of the injection lance 116 is partially fractionated in the fractionation line 223 by the suction pump 226 and passes through the three-way valve 224, and after the pulverized coal 2 and the like are removed by the filter device 225A, the carbon monoxide concentration of the carrier gas 107 is detected by the CO sensor 221, and the carrier gas 107 is then returned from the return line 227 via the suction pump 226 to near the proximal side of the injection lance 116.

Then, the control unit 222 controls the blast volume of the air blower 117 and the openness of the flow rate adjustment valve 118 on the basis of information from the CO sensor 221. Specifically, the carbon monoxide concentration in the carrier gas 107 is a value substantially determined by the type of the pulverized coal 2 (coal type), the supply quantity of the pulverized coal 2, the oxygen concentration in the carrier gas 107, and the temperature of the carrier gas 107.

For this reason, the temperature of the carrier gas 107 can be determined by detecting the carbon monoxide concentration in the carrier gas 107 since the supply quantity and type of the pulverized coal 2 (coal type) are predetermined and the oxygen concentration in the carrier gas 107 can be calculated.

More specifically, the control unit 222 calculates the temperature of the carrier gas 107 on the basis of information from the CO sensor 221, that is, the carbon monoxide concentration of sampled carrier gas 107, in other words, the carbon monoxide concentration and the like in the carrier gas 107 near the tuyere, and if that temperature is less than 200° C., the control unit 222 controls the air blower 117 and the flow rate adjustment valve 118 so as to increase the burning capacity of the pulverized coal 2 being pneumatically conveyed to the injection lance 116, to increase the blast volume of the air blower 117 and reduce the openness of the flow rate adjustment valve 118 so as to increase the oxygen concentration in the carrier gas 107 while holding the flow rate of the carrier gas 107 constant.

On the other hand, if the calculated temperature is greater than T° C., the control unit 222 controls the air blower 117 and the flow rate adjustment valve 118 so as to decrease the burning capacity of the pulverized coal 2 being pneumatically conveyed to the injection lance 116, to decrease the blast volume of the air blower 117 and increase the openness of the flow rate adjustment valve 118 so as to decrease the oxygen concentration in the carrier gas 107 while holding the flow rate of the carrier gas 107 constant.

As a result, similar to the embodiment described above, the pulverized coal 2 blown into the hot air 101 from the injection lance 116 and burned in the interior of the blow pipe 115 becomes a flame and forms a raceway from the tuyere to the interior of the blast furnace body 110, and burns the coal and the like in the starting material 1 inside the blast furnace body 110, and the iron ore in the starting material 1 is reduced to result in pig iron (molten iron) 9, which can be drawn out from the taphole 110a.

Furthermore, since the filter device 225A gradually becomes clogged due to sampling of the carrier gas 107, sampling of the carrier gas 107 can be continuously performed by opening and closing the three-way valve 224 so as to connect only the filter device 225B to the fractionation line 223 and the return line 227 and replacing the filter device 225A with a new one after a prescribed time has elapsed.

In short, in the blast furnace installation 100 pertaining to the embodiment described above, the temperature of the carrier gas 107 is directly detected by the temperature sensor 121 provided near the proximal side of the injection lance 116, but in the blast furnace installation 200 pertaining to this embodiment, the temperature of the carrier gas 107 is determined by calculation by the control unit 222 by sampling the carrier gas 107 near the proximal side of the injection lance 116 by a sampling line and detecting its carbon monoxide concentration by a CO sensor 221.

For this reason, in the blast furnace installation 200 pertaining to this embodiment, the temperature of the carrier gas 107 can be detected without sticking the detector part of a sensor or the like into the line through which the majority of the carrier gas 107 flows.

Therefore, by the blast furnace installation 200 pertaining to this embodiment, since the same effects as the previously described embodiment can naturally be obtained and adhesion and the like of the pulverized coal 2 to the detector part of the sensor can be prevented, more accurate control can be performed, and blockage and the like near the proximal side of the injection lance 116 can be prevented.

### OTHER EMBODIMENTS

Furthermore, in the second embodiment described above, the temperature of the carrier gas 107 is determined by detecting the carbon monoxide concentration in the carrier gas 107 by the CO sensor 221, but as another embodiment, the temperature of the carrier gas 107 can also be determined by employing, for example, a CO₂ sensor that detects the carbon dioxide concentration or an O₂ sensor that detects the oxygen concentration in the carrier gas 107, instead of the CO sensor 221.

In the first and second embodiments described above, the case where inert gas 102 such as nitrogen gas is fed from the inert gas supply source 119 was described, but as another embodiment, for example, blast furnace off-gas (approximately 200° C.) discharged from the blast furnace body 110 or combustion exhaust gas (approximately 100° C.) of blast furnace off-gas, which has been generated after the blast furnace off-gas is combusted with air and has been used as a heat source of the hot air 101, may be employed as the inert gas 102. That is, the blast furnace body 110 or the hot air feeding device 114 or the like may also be used as the inert gas supply source.

### INDUSTRIAL APPLICABILITY

The blast furnace installation pertaining to the present invention can be used extremely advantageously in the iron-making industry because it can reduce the production cost of pig iron.

### REFERENCE SIGNS LIST

1 Starting material
2 Pulverized coal
9 Molten iron
100 Blast furnace installation
101 Hot air
102 Inert gas
106 Air
107 Carrier gas
110 Blast furnace body
110a Taphole
111 Starting material dispensing device
112 Charging conveyor
113 Throat hopper
114 Hot air feeding device
115 Blow pipe
116 Injection lance
117 Air blower
118 Flow rate adjustment valve
119 Inert gas supply source
120 Supply tank
121 Temperature sensor
122 Control unit
200 Blast furnace installation
221 CO sensor
222 Control unit
223 Fractionation line
224 Three-way valve
225A, 225B Filter devices
226 Suction pump
227 Return line

1. A blast furnace installation including:
a blast furnace body;
starting material charging means for charging starting material from a top into an interior of the blast furnace body;
hot air blowing means for blowing hot air into the interior of the blast furnace body through a tuyere; and
pulverized coal supply means for supplying pulverized coal into the interior of the blast furnace body through the tuyere; wherein
the pulverized coal is obtained by means of dry distillation of low-grade coal; and
the pulverized coal supply means includes:
pneumatic conveying means for pneumatically conveying the pulverized coal to the tuyere by means of a carrier gas made of a mixture of air and an inert gas;
carrier gas state detection means for detecting a state of the carrier gas near the tuyere; and
control means for adjusting a mixing ratio between the air and the inert gas in the carrier gas of the pneumatic conveying means based on information from the carrier gas state detection means.

2. The blast furnace installation according to claim 1, wherein
the carrier gas state detection means of the pulverized coal supply means detects at least one state among temperature, oxygen concentration, carbon monoxide concentration and carbon dioxide concentration of the carrier gas.

3. The blast furnace installation according to claim 1, wherein
the control means of the pulverized coal supply means adjusts a mixing ratio between the air and the inert gas in the carrier gas of the pneumatic conveying means such that the temperature of the carrier gas is from 200° C. to T° C. (wherein T is a dry distillation temperature of the low-grade coal).

4. The blast furnace installation according to claim 1, wherein
the pulverized coal is dry-distilled at from 400° C. to 600° C.

5. The blast furnace installation according to claim 1, wherein
the pulverized coal has a diameter of not more than 100 μm.

6. The blast furnace installation according to claim 1, wherein
the low-grade coal is sub-bituminous coal or lignite.

7. The blast furnace installation according to claim 1, wherein
the inert gas is at least one among nitrogen gas, off-gas discharged from the blast furnace body, and combustion exhaust gas after the off-gas has been combusted with air.
